(19) United States
(12) Patent Application Publication
(10) Pub. No.: US 2020/0387826 A1
(43) Pub. Date: Dec. 10, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/661,042

(22) Filed: Oct. 23, 2019

(30) Foreign Application Priority Data
Jun. 4, 2019 (JP) 2019-104155

(51) Int. Cl. G06N 20/00

(52) U.S. Cl. CPC G06N 20/00

(57) ABSTRACT

An information processing apparatus includes a receiving unit that receives learning data; and a changing unit that changes learning processing of artificial intelligence in accordance with information attached to the learning data and indicating whether or not to permit the artificial intelligence to learn the learning data.

### CROSS-REFERENCE TO RELATED APPLICATIONS

This application is based on and claims priority under 35 USC 119 from Japanese Patent Application No. 2019-104155 filed Jun. 4, 2019.

### BACKGROUND

### (i) Technical Field

The present disclosure relates to an information processing apparatus and a non-transitory computer readable medium.

### (ii) Related Art

In general, learning data is learned by artificial intelligence.

Japanese Unexamined Patent Application Publication No. 2010-223824 describes an apparatus for preventing repeated learning of a wrong new road.

### SUMMARY

Sometimes, some learning data are not desired to be learned by artificial intelligence.

Aspects of non-limiting embodiments of the present disclosure relate to preventing artificial intelligence from learning learning data that is not desired to be learned by the artificial intelligence.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a receiving unit that receives learning data; and a changing unit that changes learning processing of artificial intelligence in accordance with information attached to the learning data and indicating whether or not to permit the artificial intelligence to learn the learning data.

### BRIEF DESCRIPTION OF THE DRAWINGS

Exemplary embodiments of the present disclosure will be described in detail based on the following figures, wherein:

FIG. 1 is a block diagram illustrating a configuration of an information processing apparatus according to a first exemplary embodiment;

FIG. 2 illustrates learning data according to the first exemplary embodiment;

FIG. 3 illustrates content data according to the first exemplary embodiment;

FIG. 4 is a block diagram illustrating a configuration of an information processing apparatus according to a second exemplary embodiment;

FIG. 5 illustrates learning data according to the second exemplary embodiment;

FIG. 6 illustrates learning data according to the second exemplary embodiment;

FIG. 7 illustrates learning data according to the second exemplary embodiment;

FIG. 8 illustrates a database of results of determination;

FIG. 9 illustrates learning data according to a first modification of the second exemplary embodiment;

FIG. 10 illustrates learning data according to the first modification of the second exemplary embodiment;

FIG. 11 illustrates learning data according to the first modification of the second exemplary embodiment;

FIG. 12 illustrates a database of results of determination;

FIG. 13 illustrates learning data according to a second modification of the second exemplary embodiment; and

FIG. 14 illustrates learning data according to the second modification of the second exemplary embodiment.

### DETAILED DESCRIPTION

### First Exemplary Embodiment

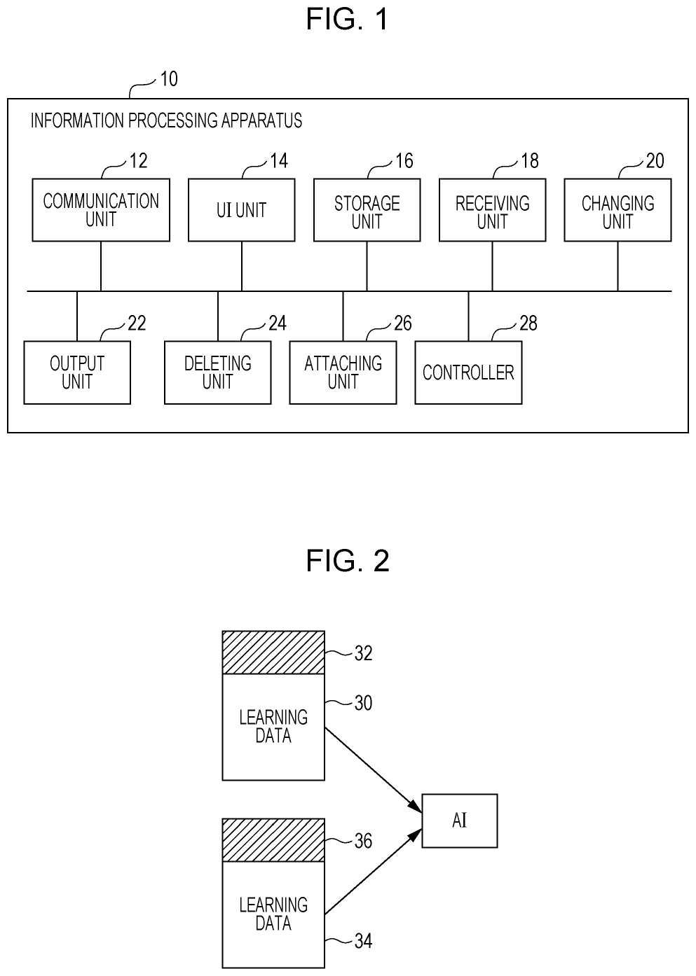

An information processing apparatus according to a first exemplary embodiment of the present disclosure is described with reference to FIG. 1. FIG. 1 illustrates an example of the information processing apparatus according to the first exemplary embodiment.

An information processing apparatus 10 according to the first exemplary embodiment is configured to receive learning data and change learning processing of the artificial intelligence in accordance with information attached to the learning data and indicating whether or not to permit artificial intelligence (i.e., AI) to learn the learning data.

The information processing apparatus 10 is, for example, a personal computer (hereinafter referred to as a “PC”), a tablet PC, a smartphone, a mobile phone, or any of other kinds of apparatuses (e.g., a multifunctional printer having functions such as a print function). Needless to say, the information processing apparatus 10 may be an apparatus other than these apparatuses.

An algorithm used in artificial intelligence is not limited in particular and may be any algorithm. The algorithm is, for example, machine learning. The machine learning may be supervised learning, or may be unsupervized learning, or may be reinforcement learning. Specifically, deep learning (e.g., multi-layer perceptron, convolutional neural network, recurrent neural network, autoencoder, restricted boltzmann machine), perceptron, back propagation, associatron, support vector machine, decision tree, k-nearest neighbor algorithm, linear regression, self-organizing map, boltzmann machine, principal component analysis, cluster analysis, Q-learning, or the like may be used. A genetic algorithm, a hill climbing method, or the like, which is an algorithm other than machine learning, may be used. Needless to say, an algorithm other than these algorithms may be used.

Learning data is data used for learning of artificial intelligence. The learning data may be data including a correct judgment (i.e., an answer) as learning data used for supervised learning or may be data that does not include a correct judgment as learning data used for unsupervized learning. The learning data is, for example, document data (e.g., text data), image data (e.g., still image data or moving image data), music data, audio data, or a combination thereof, and kind, data format, and contents thereof are not limited in particular.

Attribute information is attached to learning data. The attribute information attached to the learning data is information indicating whether or not to permit artificial intelligence to learn the learning data. The state where the attribute information is attached to the learning data means that the attribute information accompanies the learning data as accompanying information or that the attribute information is embedded in the learning data itself. The attribute information may be added to the learning data as accompanying information or may be associated with the learning data as data separate from the learning data. The state where the attribute information is embedded in the learning data itself is, for example, a state where the attribute information is disposed in an image represented by image data or a state where the attribute information is disposed in a document represented by document data.

The artificial intelligence may be mounted in the information processing apparatus 10 or may be mounted in an apparatus (e.g., a server or a PC) other than the information processing apparatus 10. That is, a program for realizing the artificial intelligence may be stored in the information processing apparatus 10 or may be stored in an apparatus other than the information processing apparatus 10.

A configuration of the information processing apparatus 10 is described in detail below.

A communication unit 12 is a communication interface and has a function of transmitting information to another apparatus and a function of receiving information from another apparatus. The communication unit 12 may have a wireless communication function or may have a wired communication function. The communication unit 12 may communicate with another apparatus through a communication path by using wireless communication or wired communication. The communication path is, for example, a network such as a local area network (LAN) or the Internet. The communication unit 12 may communicate with another apparatus without a communication path by using, for example, close-range wireless communication. The close-range wireless communication is, for example, Bluetooth (Registered Trademark), Radio Frequency Identifier (RFID), or NFC.

For example, in a case where learning data is transmitted from an apparatus other than the information processing apparatus 10 to the information processing apparatus 10, the communication unit 12 receives the learning data. In a case where attribute information is attached to the learning data, the communication unit 12 also receives the attribute information. Furthermore, the communication unit 12 may transmit the learning data to another apparatus.

A UI unit 14 is a user interface and includes a display and an operation unit. The display is a display device such as a liquid crystal display. The operation unit is an input unit such as a keyboard, an input key, or an operation panel. The UI unit 14 may be a UI unit such as a touch panel that serves as both of the display and the operation unit.

A storage unit 16 is one or more storage regions in which various kinds of information are stored. Each of the storage regions is constituted, for example, by one or more storage devices (e.g., a physical drive such as a hard disk drive or a memory) provided in the information processing apparatus 10. The learning data may be stored in the storage unit 16.

A receiving unit 18 is configured to receive learning data. For example, in a case where the communication unit 12 receives learning data transmitted from an apparatus other than the information processing apparatus 10, the receiving unit 18 receives the learning data received by the communication unit 12. In a case where the communication unit 12 receives attribute information attached to the learning data, the receiving unit 18 also receives the attribute information. Furthermore, in a case where learning data is supplied to the information processing apparatus 10 through the UI unit 14 or in a case where learning data is supplied to the information processing apparatus 10 by using a storage device (e.g., a hard disk drive, a USB memory, a CD, a DVD, or any of other portable storage media), the receiving unit 18 receives the supplied learning data. In a case where attribute information is attached to the supplied learning data, the receiving unit 18 also receives the attribute information.

A changing unit 20 is configured to change learning processing of artificial intelligence in accordance with attribute information attached to learning data.

In a case where attribute information attached to learning data indicates that artificial intelligence is permitted to learn the learning data, the changing unit 20 permits the artificial intelligence to learn the learning data. For example, in a case where a user gives an instruction to cause the artificial intelligence to learn the learning data by operating the UI unit 14, a controller 28 causes the artificial intelligence to learn the learning data. The user may designate artificial intelligence that learns the learning data and cause this artificial intelligence to learn the learning data.

In a case where attribute information attached to learning data indicates that artificial intelligence is not permitted to learn the learning data, the changing unit 20 prohibits the artificial intelligence from learning the learning data. That is, the changing unit 20 does not permit the artificial intelligence to learn the learning data. For example, even in a case where the user gives an instruction to cause the artificial intelligence to learn the learning data by operating the UI unit 14, the controller 28 does not cause the artificial intelligence to learn the learning data.

Learning of part of learning data may be permitted and the other part of the learning data may be prohibited. Alternatively, learning of all of the learning data may be permitted or prohibited. This is indicated by attribute information.

In a case where attribute information attached to learning data indicates that artificial intelligence is not permitted to learn the learning data and a purpose of learning using the learning data satisfies a predetermined criterion, the changing unit 20 may permit the artificial intelligence to learn the learning data. For example, in a case where the purpose of learning is a highly public purpose such as a medical purpose or an educational purpose, the changing unit 20 may permit the artificial intelligence to learn the learning data.

An output unit 22 is configured to output a warning in a case where attribute information attached to learning data indicates that artificial intelligence is not permitted to learn the learning data and the learning data is about to be changed without permission. The case where the learning data is about to be changed without permission is a case where a user who does not have an authority to change the learning data is trying to change the learning data.

For example, user identification information (e.g., a user name, a user ID, a password) for identifying a user who has an authority to change learning data is associated with the learning data. In a case where user identification information of a user who is trying to change learning data is associated with the learning data, the controller 28 permits the user to change the learning data. Specifically, in a case where this user executes work of changing the learning data by operating the UI unit 14, the controller 28 permits the work and changes the learning data in accordance with the user's work. In a case where user identification information of a user who is trying to change learning data is not associated with the learning data, the controller 28 prohibits the user from changing the learning data. Specifically, in a case where the user executes work of changing the learning data by operating the UI unit 14, the controller 28 prohibits the work and does not change the learning data. Note that the work of changing the learning data may be executed by an apparatus (e.g., a PC) other than the information processing apparatus 10.

For example, in a case where learning data is about to be changed (e.g., in a case where a user designates learning data by operating the UI unit 14), the controller 28 causes an entry screen for entry of user identification information of a user who has an authority to change the learning data to be displayed on the display of the UI unit 14. In a case where user identification information of a user who has an authority to change the learning data is entered on the entry screen, the controller 28 permits change of the learning data. In another example, in a case where user identification information is entered when a user logs into the information processing apparatus 10, the controller 28 may permit change of learning data in a case where the user identification information is user identification information of a user who has an authority to change the learning data.

For example, the output unit 22 may cause information indicative of a warning to be displayed on the display of the UI unit 14, may transmit information indicative of a warning to an apparatus (e.g., a PC) that has transmitted the learning data to the information processing apparatus 10, may cause a speaker to generate warning sound, or may transmit information indicative of a warning to an apparatus (e.g., a PC or the like used by an administrator) registered in advance.

A deleting unit 24 is configured to delete learning data in a case where attribute information attached to the learning data indicates that artificial intelligence is not permitted to learn the learning data and the learning data is about to be changed without permission. As described above, the case where learning data is about to be changed without permission is a case where a user who does not have an authority to change the learning data is trying to change the learning data.

For example, in a case where learning data that is about to be changed without permission is stored in the storage unit 16, the deleting unit 24 deletes the learning data from the storage unit 16. In a case where learning data that is about to be changed without permission is stored in an apparatus (e.g., a PC or a server) other than the information processing apparatus 10, the deleting unit 24 may delete the learning data from the other apparatus.

Furthermore, in a case where the receiving unit 18 receives learning data which artificial intelligence is not permitted to learn, the deleting unit 24 may delete the learning data.

An attaching unit 26 is configured to attach attribute information indicating whether or not to permit use of content data as learning data of artificial intelligence to the content data. The content data is, for example, document data (e.g., text data), image data (e.g., still image data or moving image data), music data, audio data, or a combination thereof, and kind, data format, contents thereof are not limited in particular. The content data to which attribute information is attached is an example of learning data to which attribute information is attached.

The attaching unit 26 may be provided in another apparatus different from the information processing apparatus 10 in which the changing unit 20 is provided. In this case, the processing of the attaching unit 26 is executed by the other apparatus.

The controller 28 is configured to control operation of each unit of the information processing apparatus 10.

Processing of the information processing apparatus 10 is described below with reference to FIG. 2. FIG. 2 illustrates an example of learning data according to the first exemplary embodiment.

Attribute information 32 is attached to learning data 30. The attribute information 32 is information indicating that artificial intelligence is permitted to learn the learning data 30. Attribute information 36 is attached to learning data 34. The attribute information 36 is information indicating that artificial intelligence is not permitted to learn the learning data 34.

In a case where the learning data 30 is about to be learned by artificial intelligence (“AI” in FIG. 2) (e.g., in a case where a user gives an instruction to cause the artificial intelligence to learn the learning data 30), the changing unit 20 permits the artificial intelligence to learn the learning data 30 or prohibits the artificial intelligence from learning the learning data 30 on the basis of the attribute information 32 attached to the learning data 30. Since the attribute information 32 is information indicating that artificial intelligence is permitted to learn the learning data 30, the changing unit 20 permits the artificial intelligence to learn the learning data 30.

Similarly, in a case where the learning data 34 is about to be learned by artificial intelligence, the changing unit 20 permits the artificial intelligence to learn the learning data 34 or prohibits the artificial intelligence from learning the learning data 34 on the basis of the attribute information 36 attached to the learning data 34. Since the attribute information 36 is information indicating that artificial intelligence is not permitted to learn the learning data 34, the changing unit 20 prohibits the artificial intelligence from learning the learning data 34. This makes it possible to prevent artificial intelligence from learning learning data that is not desired to be learned by the artificial intelligence.

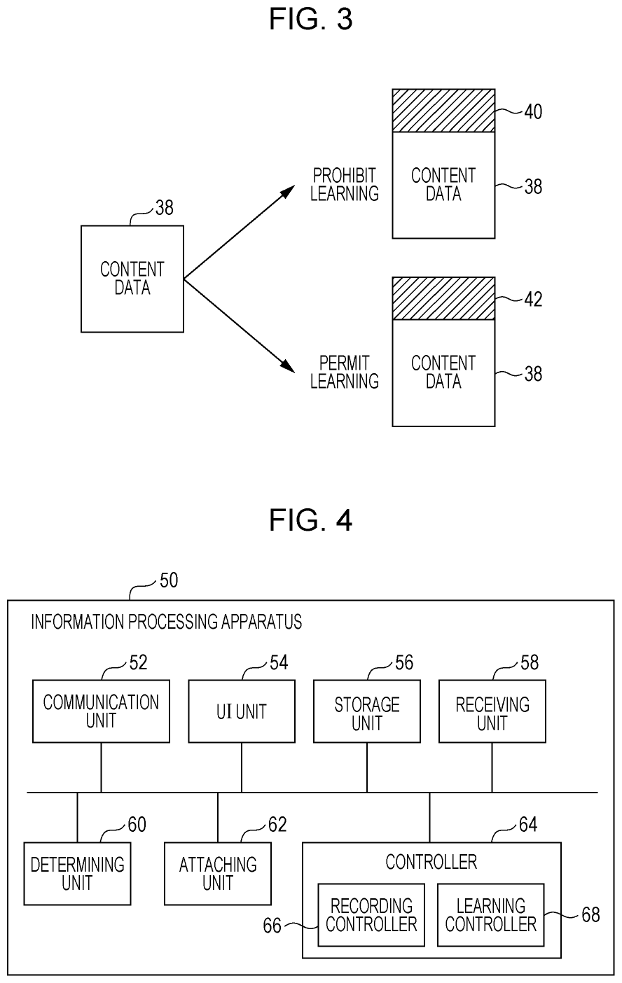

Processing for creating learning data is described below with reference to FIG. 3. FIG. 3 illustrates an example of content data according to the first exemplary embodiment.

The attaching unit 26 attaches attribute information to content data 38. The content data 38 to which the attribute information is attached is an example of learning data to which attribute information is attached. Attribute information 40 is information indicating that artificial intelligence is not permitted to learn the content data 38. The content data 38 to which the attribute information 40 is attached is prohibited from being learned by artificial intelligence. Attribute information 42 is information indicating that artificial intelligence is permitted to learn the content data 38. The content data 38 to which the attribute information 42 is attached is permitted to be learned by artificial intelligence.

For example, a user may designate the content data 38 to which attribute information is to be attached by operating the UI unit 14 and designate whether or not to permit artificial intelligence to learn the content data 38. In a case where the user permits artificial intelligence to learn the content data 38, the attaching unit 26 attaches the attribute information 42 indicating that artificial intelligence is permitted to learn the content data 38 to the content data 38 designated by the user. In a case where the user does not permit artificial intelligence to learn the content data 38, the attaching unit 26 attaches the attribute information 40 indicating that artificial intelligence is not permitted to learn the content data 38 to the content data 38 designated by the user. Needless to say, attribute information may be attached to learning data by an apparatus (e.g., a PC or a server) other than the information processing apparatus 10.

The user who designates whether or not to permit artificial intelligence to learn the content data 38 may be a user who created the content data 38, may be a user who provided the content data 38, may be a user who purchased the content data 38, may be a user who has an authority to use the content data 38, may be an administrator who manages the content data 38, or may be a user other than these users.

For example, the user who created the content data 38 may designate whether or not to permit artificial intelligence to learn the content data 38 created by this user. This also applies to other users. For example, when the content data 38 is created, the attaching unit 26 attaches attribute information to the content data 38. The attaching unit 26 may attach attribute information to the content data 38 in a case where a user gives an instruction to attach attribute information to the content data 38 or may attach attribute information to the content data 38 without a user's instruction when the content data 38 is completed.

The attaching unit 26 may attach attribute information to the content data 38 without a user's instruction. For example, in a case where the content data 38 includes a wrong answer, the attaching unit 26 attaches the attribute information 40 indicating that artificial intelligence is not permitted to learn the content data 38 to the content data 38. The case where the content data 38 includes a wrong answer is, for example, a case where the content data 38 used as learning data for translation includes wrong translation data, a case where the content data 38 used as learning data for image recognition includes information indicative of an object different from an object represented by the content data 38, or a case where the content data 38 used as learning data for character recognition includes information indicative of a character different from a character represented by the content data 38.

The attaching unit 26 determines whether or not the content data 38 includes a wrong answer by analyzing the content data 38 and attaches the attribute information 40 indicating that artificial intelligence is not permitted to learn the content data 38 to the content data 38 in a case where the content data 38 includes a wrong answer. The attaching unit 26 may attach the attribute information 40 indicating that artificial intelligence is not permitted to learn the content data 38 to the content data 38 in a case where a ratio of wrong answers or the number of appearances of a wrong answer is equal to or larger than a predetermined threshold value.

In a case where the content data 38 does not include a wrong answer, the attaching unit 26 attaches the attribute information 42 indicating that artificial intelligence is permitted to learn the content data 38 to the content data 38. The attaching unit 26 may attach the attribute information 42 indicating that artificial intelligence is permitted to learn the content data 38 to the content data 38 in a case where a ratio of wrong answers or the number of appearances of a wrong answer is less than a predetermined threshold value.

In a case where the content data 38 includes information concerning security, the attaching unit 26 may attach the attribute information 40 indicating that artificial intelligence is not permitted to learn the content data 38 to the content data 38. In a case where the content data 38 does not include information concerning security, the attaching unit 26 attaches the attribute information 42 indicating that artificial intelligence is permitted to learn the content data 38 to the content data 38. The information concerning security is, for example, personal information, information concerning a trade secret, or information set as non-disclosed information by a public institution (e.g., an administrative institution). The personal information is, for example, information indicative of a name, a birth date, a user ID, a password, and the like of a specific individual. The attaching unit 26 determines whether or not the content data 38 includes information concerning security by analyzing the content data 38. In a case where the content data 38 includes information concerning security, the attribute information 40 indicating that artificial intelligence is not permitted to learn is attached to the content data 38, and therefore leakage of the information concerning security resulting from learning of the content data 38 by artificial intelligence is prevented.

Attribute information attached to learning data may include permission period information indicative of a permission period in which artificial intelligence is permitted to learn the learning data. That is, a period in which learning of learning data is permitted may be restricted. A period other than the permission period is a period in which artificial intelligence is prohibited from learning learning data. The permission period is decided, for example, by a date, a time zone, a time, or the like. In a case where a point in time (e.g., a date or a time) at which the learning data is about to be learned by artificial intelligence is included in the permission period, the changing unit 20 permits the artificial intelligence to learn the learning data. In a case where the point in time at which the learning data is about to be learned by artificial intelligence is not included in the permission period, the changing unit 20 prohibits the artificial intelligence from learning the learning data. For example, a period other than the permission period may be set as a period in which learning data is not publicly known, and the permission period may be set as a period in which learning data is publicly known. According to this setting, artificial intelligence is permitted to learn the learning data in the period in which the learning data is publicly known, and artificial intelligence is prohibited from learning the learning data in the period in which the learning data is not publicly known. Needless to say, the permission period may be set based on a different reason. The permission period may be set by a user who has an authority to set the permission period. For example, attribute information including permission period information is attached to learning data when the learning data is created. This processing may be executed by the attaching unit 26.

Attribute information attached to learning data may include number information indicative of a limit on the number of times of learning of the learning data. The controller 28 counts the number of times of learning of learning data by artificial intelligence and attaches information indicative of the number to the learning data. In a case where the number of times of learning exceeds a limit on the number of times of learning, learning of the learning data is prohibited. Even in a case where a user gives an instruction to cause artificial intelligence to learn learning data whose number of times of learning exceeds the limit, the controller 28 does not cause the artificial intelligence to learn the learning data. Even in a case where an apparatus other than the information processing apparatus 10 is used for learning of artificial intelligence, learning data whose number of times of learning exceeds the limit is not learned by artificial intelligence. The number of times of learning may be set by a user who has an authority to set a limit on the number of times of learning. Note that the number of times of learning of learning data whose number of times of learning exceeded the limit may be set to 0 by the user who has an authority to set a limit on the number of times of learning. For example, attribute information including number information is attached to the learning data when the learning data is created. This processing may be executed by the attaching unit 26.

Attribute information attached to learning data may include information indicating whether or not artificial intelligence is permitted to learn the learning data in accordance with usage of the learning data. For example, in a case where learning data is data concerning a medical field or data used for a medical field, predetermined artificial intelligence is permitted to learn the learning data, and artificial intelligence other than the predetermined artificial intelligence is prohibited from learning the learning data. The predetermined artificial intelligence is, for example, artificial intelligence mounted in the information processing apparatus 10 or artificial intelligence mounted in a predetermined apparatus (e.g., a PC). The predetermined apparatus is, for example, a medical facility (e.g., a hospital or a building of a medical school). Artificial intelligence mounted in an apparatus other than these apparatuses is prohibited from learning the learning data. Since the data concerning a medical field or the data used for the medical field sometimes includes personal information, only learning of the predetermined artificial intelligence is permitted, and learning of artificial intelligence other than the predetermined artificial intelligence is prohibited. This can prevent or suppress leakage of the personal information. This also applies to a case where the learning data is data in a field other than the medical field. Artificial intelligence permitted to learn learning data and an apparatus in which the artificial intelligence is mounted may be set by a user who has an authority to make this setting. For example, attribute information including information indicative of artificial intelligence permitted to learn learning data and attribute information including information indicative of an apparatus in which the artificial intelligence is mounted are attached to the learning data when the learning data is created. This processing may be executed by the attaching unit 26.

Attribute information attached to learning data may include information indicating whether or not artificial intelligence is permitted to learn the learning data in accordance with a system of the artificial intelligence. The system of the artificial intelligence is an algorithm used in the artificial intelligence. Learning data suitable for learning sometimes differs depending on the algorithm of the artificial intelligence. For example, in a case where artificial intelligence learns learning data, performance of the artificial intelligence improves in some cases and decreases in other cases depending on an algorithm of the artificial intelligence. Furthermore, the performance of the artificial intelligence does not change in some cases. Learning data that improves performance of artificial intelligence as a result of learning is learning data suitable for learning of the artificial intelligence. Artificial intelligence whose performance improves as a result of learning of learning data is artificial intelligence permitted to learn the learning data. Meanwhile, artificial intelligence whose performance does not improve (i.e., artificial intelligence whose performance decreases or artificial intelligence whose performance does not change) as a result of learning of learning data is artificial intelligence prohibited from learning the learning data. For example, whether or not performance of each artificial intelligence improves as a result of learning is decided on the basis of a learning history of learning of each learning data by the artificial intelligence. Attribute information attached to learning data includes information indicative of an algorithm of artificial intelligence whose performance improves as a result of learning of the learning data as information indicative of an algorithm of artificial intelligence permitted to learn the learning data. For example, when learning data is created, attribute information including information indicative of an algorithm of artificial intelligence whose performance improves as a result of learning of the learning data is attached to the learning data. This processing may be executed by the attaching unit 26. In a case where an algorithm of artificial intelligence that learns learning data is an algorithm of artificial intelligence whose performance improves as a result of learning of the learning data, the changing unit 20 permits the artificial intelligence to learn the learning data. In a case where an algorithm of artificial intelligence that learns learning data is an algorithm of artificial intelligence whose performance does not improve as a result of learning of the learning data, the changing unit 20 prohibits the artificial intelligence from learning the learning data. This allows artificial intelligence to learn learning data that improves performance of the artificial intelligence. Learning data that does not change performance of artificial intelligence as a result of learning may be set as learning data which the artificial intelligence is permitted to learn.

Attribute information attached to learning data may include, for each field of use of artificial intelligence, information indicating whether or not to permit the artificial intelligence to learn the learning data. For example, information indicative of a field in which learning is permitted is included in attribute information. The field is, for example, medicine, education, character recognition, translation, or business. Needless to say, a field other than these fields may be a field of use of artificial intelligence. For example, in a case where information indicative of a medical field is included in attribute information as information indicative of a field in which learning is permitted, learning data to which the attribute information is attached is learning data which artificial intelligence used in a medical field is permitted to learn. In a case where artificial intelligence that learns the learning data is artificial intelligence used in a medical field, the changing unit 20 permits the artificial intelligence to learn the learning data. In a case where artificial intelligence that learns the learning data is artificial intelligence that is not used in a medical field, the changing unit 20 prohibits the artificial intelligence from learning the learning data. This allows artificial intelligence to learn learning data suitable for a field of use of the artificial intelligence. For example, when learning data is created, attribute information including information indicative of a field in which learning of the learning data is permitted is attached to the learning data. This processing may be executed by the attaching unit 26. Information indicative of plural fields may be included in the attribute information. In this case, artificial intelligence used in at least one of the plural fields may be permitted to learn the learning data or artificial intelligence used in all of the plural fields may be permitted to learn the learning data.

The changing unit 20 may permit artificial intelligence to learn or prohibit artificial intelligence from learning learning data in accordance with a user who uses the learning data. For example, attribute information attached to learning data includes user identification information of a user permitted to cause artificial intelligence to learn the learning data. In a case where user identification information of a user who has given an instruction to learn learning data is included in attribute information attached to the learning data, the changing unit 20 permits artificial intelligence to learn the learning data. In a case where user identification information of a user who has given an instruction to learn learning data is not included in the learning data, the changing unit 20 prohibits artificial intelligence from learning the learning data. For example, when learning data is created, attribute information including user identification information of a user permitted to cause artificial intelligence to learn the learning data is attached to the learning data. This processing may be executed by the attaching unit 26.

In the first exemplary embodiment, in a case where artificial intelligence is prohibited from learning learning data, the controller 28 may transmit, to a creator who created the learning data, information inquiring whether or not to permit artificial intelligence to learn the learning data. For example, attribute information attached to learning data includes information indicative of an e-mail address of a creator who created the learning data or an address of an apparatus used by the creator. The controller 28 transmits inquiry information to the e-mail address or the address of the apparatus. In a case where the creator permits artificial intelligence to learn the learning data, information indicative of the permission is transmitted to the information processing apparatus 10 by e-mail or transmitted to the information processing apparatus 10 from the apparatus used by the creator. In this case, the changing unit 20 permits artificial intelligence to learn the learning data. In a case where the creator prohibits artificial intelligence from learning the learning data, information indicative of the prohibition is transmitted to the information processing apparatus 10 by e-mail or transmitted to the information processing apparatus 10 from the apparatus used by the creator. In this case, the changing unit 20 prohibits artificial intelligence from learning the learning data.

In the first exemplary embodiment, in a case where attribute information indicating that artificial intelligence is prohibited from learning learning data is attached to the learning data received by the receiving unit 18, the changing unit 20 may prohibit artificial intelligence from learning the learning data. In a case where attribute information indicating that artificial intelligence is prohibited from learning learning data is not attached to the learning data received by the receiving unit 18, the changing unit 20 permits artificial intelligence to learn the learning data. In this example, the changing unit 20 is an example of a prohibiting unit.

In another example, in a case where attribute information indicating that artificial intelligence is permitted to learn learning data is attached to the learning data received by the receiving unit 18, the changing unit 20 may permit artificial intelligence to learn the learning data. In a case where attribute information indicating that artificial intelligence is permitted to learn learning data is not attached to the learning data received by the receiving unit 18, the changing unit 20 prohibits artificial intelligence from learning the learning data. In this example, the changing unit 20 is an example of a permitting unit.

The processing of the changing unit 20, the output unit 22, the deleting unit 24, and the attaching unit 26 may be executed by artificial intelligence. For example, artificial intelligence instructed to learn learning data may execute these kinds of processing.

### Second Exemplary Embodiment

An information processing apparatus according to a second exemplary embodiment of the present disclosure is described with reference to FIG. 4. FIG. 4 illustrates an example of the information processing apparatus according to the second exemplary embodiment.

An information processing apparatus 50 according to the second exemplary embodiment is configured to classify learning data learned by artificial intelligence as influential learning data that has influenced performance of the artificial intelligence and non-influential learning data that has not influenced performance of the artificial intelligence. The information processing apparatus 50 may classify learning data as influential learning data or non-influential learning data and then record the learning data in a recording unit.

The information processing apparatus 50 may classify influential learning data learned by artificial intelligence as improving learning data that has improved performance of the artificial intelligence or decreasing learning data that has decreased performance of the artificial intelligence. The information processing apparatus 50 may classify influential learning data as improving learning data or decreasing learning data and then record the influential learning data in the recording unit.

The information processing apparatus 50 may classify learning data learned by artificial intelligence as improving learning data who has improved performance of the artificial intelligence or non-improving learning data that has not improved performance of the artificial intelligence. The information processing apparatus 50 may classify learning data as improving learning data or non-improving learning data and then record the learning data in the recording unit.

The information processing apparatus 50 is, for example, a PC, a tablet PC, a smartphone, a mobile phone, or any of other kinds of apparatuses (e.g., a multifunctional printer having functions such as a print function). Needless to say, an apparatus other than these apparatuses may be the information processing apparatus 50.

As in the first exemplary embodiment, an algorithm used in artificial intelligence is not limited in particular, and an algorithm described in the first exemplary embodiment may be used.

Learning data is data used for learning of artificial intelligence. As in the first exemplary embodiment, learning data may be learning data used for supervised learning or may be learning data used for unsupervized learning. A kind, a data format, and contents of learning data are not limited in particular.

Artificial intelligence may be mounted in the information processing apparatus 50 or may be mounted in an apparatus (e.g., a server or a PC) other than the information processing apparatus 50. That is, a program for realizing artificial intelligence may be stored in the information processing apparatus 10 or may be stored in an apparatus other than the information processing apparatus 10.

A configuration of the information processing apparatus 50 is described in detail below.

A communication unit 52 is a communication interface and has a function of transmitting information to another apparatus and a function of receiving information from another apparatus. The communication unit 52 may have a wireless communication function or may have a wired communication function. The communication unit 52 may communicate with another apparatus through a communication path by using wireless communication or wired communication. The communication path is, for example, a network such as a LAN or the Internet. The communication unit 52 may communicate with another apparatus without a communication path by using, for example, close-range wireless communication. The close-range wireless communication is, for example, Bluetooth (Registered Trademark), RFID, or NFC.

For example, in a case where learning data is transmitted from an apparatus other than the information processing apparatus 50 to the information processing apparatus 50, the communication unit 52 receives the learning data. Furthermore, the communication unit 52 may transmit the learning data to another apparatus.

A UI unit 54 is a user interface and includes a display and an operation unit. The display is a display device such as a liquid crystal display. The operation unit is an input unit such as a keyboard, an input key, or an operation panel. The UI unit 54 may be a UI unit such as a touch panel that serves as both of the display and the operation unit.

A storage unit 56 is one or more storage regions in which various kinds of information are stored. Each of the storage regions is constituted, for example, by one or more storage devices (e.g., a physical drive such as a hard disk drive or a memory) provided in the information processing apparatus 50. Learning data may be stored in the storage unit 56.

A receiving unit 58 is configured to receive learning data. For example, in a case where the communication unit 52 receives learning data transmitted from an apparatus other than the information processing apparatus 50, the receiving unit 58 receives the learning data received by the communication unit 52. Furthermore, in a case where learning data is supplied to the information processing apparatus 50 through the UI unit 54 or in a case where learning data is supplied to the information processing apparatus 50 by using a storage device (e.g., a hard disk drive, a USB memory, a CD, a DVD, or any of other portable storage media), the receiving unit 58 receives the supplied learning data.

A determining unit 60 is configured to determine whether or not learning data learned by artificial intelligence has influenced performance of the artificial intelligence and classify the learning data as influential learning data that has influenced performance of the artificial intelligence or non-influential learning data that has not influenced performance of the artificial intelligence. This makes it clear whether or not the learning data has influenced performance of the artificial intelligence. The learning data classified as the influential learning data or the non-influential learning data may be recorded in the recording unit.

A scope of the concept of the influential learning data encompasses improving learning data that has improved performance of artificial intelligence and decreasing learning data that has decreased performance of artificial intelligence. The non-influential learning data is learning data that has not changed performance of artificial intelligence as a result of learning. This makes it clear whether or not learning data has improved or decreased performance of artificial intelligence. In a case where a difference in performance of artificial intelligence before and after learning of learning data is less than a threshold value, the determining unit 60 may classify the learning data as non-influential learning data.

The determining unit 60 may classify influential learning data learned by artificial intelligence as improving learning data that has improved performance of the artificial intelligence or decreasing learning data that has decreased performance of the artificial intelligence. Learning data classified into improving learning data or decreasing learning data may be recorded in the recording unit.

Performance of artificial intelligence is performance concerning a function of the artificial intelligence and is, for example, performance concerning a character recognition function, performance concerning an image recognition function, performance concerning a voice recognition function, performance concerning an object recognition function, performance concerning a translation function, performance concerning creativity (e.g., creativity in a field such as business or art), or performance concerning problem-solving ability (ability to solve a problem in a field such as business). Needless to say, these functions are merely examples of a function of artificial intelligence, and performance other than these kinds of performance may be encompassed within the scope of the concept of performance of artificial intelligence.

The determining unit 60 may classify, for each artificial intelligence, learning data as influential learning data or non-influential learning data. Furthermore, the determining unit 60 may classify, for each artificial intelligence, learning data as improving learning data or decreasing learning data.

The determining unit 60 may classify, for each function of artificial intelligence, learning data as influential learning data or non-influential learning data. Furthermore, the determining unit 60 may classify, for each function of artificial intelligence, learning data as improving learning data or decreasing learning data.

The determining unit 60 executes a test for determining whether or not learning data to be determined has influenced performance of artificial intelligence. For example, the determining unit 60 causes artificial intelligence to learn learning data to be determined and determines whether or not performance of the artificial intelligence has changed before and after the learning.

For example, in a case where it is determined whether or not learning data to be determined has influenced performance concerning a character recognition function, the determining unit 60 first gives predetermined document data (e.g., document data for test) to artificial intelligence that has not learned the learning data to be determined, causes the artificial intelligence to recognize characters included in the document data, and calculates character recognition accuracy (e.g., a character recognition rate).

Next, the determining unit 60 causes the artificial intelligence to learn the learning data to be determined. Next, the determining unit 60 gives the document data to the artificial intelligence that has learned the learning data to be determined, causes the artificial intelligence to recognize the characters included in the document data, and calculates character recognition accuracy.

The determining unit 60 determines whether or not the character recognition accuracy has changed before and after the learning. In a case where the character recognition accuracy has changed before and after the learning, the determining unit 60 determines that the learning data to be determined is learning data that has influenced performance concerning the character recognition function of the artificial intelligence, whereas in a case where the character recognition accuracy has not changed before and after the learning, the determining unit 60 determines that the learning data to be determined is learning data that has not influenced performance concerning the character recognition function of the artificial intelligence. In a case where the character recognition accuracy has changed before and after the learning, the determining unit 60 classifies the learning data to be determined as influential learning data, whereas in a case where the character recognition accuracy has not changed before and after the learning, the determining unit 60 classifies the learning data to be determined as non-influential learning data.

Furthermore, in a case where the character recognition accuracy after the learning is higher than the character recognition accuracy before the learning, the determining unit 60 determines that the learning data to be determined is learning data that has improved performance concerning the character recognition function of the artificial intelligence, whereas in a case where the character recognition accuracy after the learning is lower than the character recognition accuracy before the learning, the determining unit 60 determines that the learning data to be determined is learning data that has decreased the performance concerning the character recognition function of the artificial intelligence. In a case where the character recognition accuracy after the learning is higher than the character recognition accuracy before the learning, the determining unit 60 classifies the learning data to be determined as improving learning data, whereas in a case where the character recognition accuracy after the learning is lower than the character recognition accuracy before the learning, the determining unit 60 classifies the learning data to be determined as non-improving learning data.

It is also determined whether or not the learning data to be determined has influenced other kinds of performance of artificial intelligence as in the case of the performance concerning the character recognition function. For example, image recognition accuracy (e.g., image recognition rate) of image data for test is calculated before and after the artificial intelligence learns image data that is learning data, and the learning data is classified on the basis of a result of the calculation. For example, it is assumed that artificial intelligence that has not learned image data representing a cat and cannot recognize a cat by analyzing image data representing a cat learns image data representing a cat as learning data. In a case where the artificial intelligence becomes able to recognize a cat by analyzing the image data representing a cat as a result of the learning, this means that performance concerning an image recognition function has improved. In a case where the artificial intelligence cannot recognize a cat by analyzing the image data representing a cat as a result of the learning, this means that performance concerning the image recognition function has not improved.

The determining unit 60 may determine whether or not learning data learned by artificial intelligence has improved performance of the artificial intelligence and classify the learning data as improving learning data that has improved the performance of the artificial intelligence or non-improving learning data that has not improved the performance of the artificial intelligence. This makes it clear whether or not the learning data has improved the performance of the artificial intelligence. The learning data classified as improving learning data or non-improving learning data may be recorded in the recording unit. In a case where a difference between performance of the artificial intelligence before learning of the learning data and performance of the artificial intelligence after learning of the learning data is less than a threshold value, the determining unit 60 may classify the learning data as non-improving learning data. The determining unit 60 may determine, for each artificial intelligence, whether or not learning data learned by the artificial intelligence has improved performance of the artificial intelligence and classify, for each function of artificial intelligence, learning data as improving learning data or non-improving learning data.

Note that learning data to be determined may be learning data designated by a user or may be learning data designated in advance as the learning data to be determined.

An attaching unit 62 is configured to attach determination result information indicative of a result of determination of the determining unit 60 to learning data to be determined. The attaching unit 62 may attach determination result information to learning data to be determined as accompanying information or may embed determination result information in learning data to be determined itself. Note that the attaching unit 62 may attach attribute information according to the first exemplary embodiment to learning data.

A controller 64 is configured to control operation of each unit of the information processing apparatus 50. The controller 64 includes a recording controller 66 and a learning controller 68.

The recording controller 66 is configured to record, in the recording unit, learning data to which determination result information is attached. For example, the recording controller 66 classifies learning data to be determined as influential learning data or non-influential learning data and then records the learning data to be determined in the recording unit. The recording controller 66 may classify influential learning data as improving learning data or decreasing learning data and then record the influential learning data in the recording unit. The recording controller 66 may classify learning data as improving learning data or non-improving learning data and then record the learning data in the recording unit. The recording unit in which learning data is recorded may be provided in the information processing apparatus 50 or may be provided in an apparatus (e.g., a server or a PC) other than the information processing apparatus 50. The recording unit in which learning data may be designated by a user or may be determined in advance.

The recording controller 66 may cause learning history information indicative of a learning history of artificial intelligence to be recorded in the recording unit in association with learning data to be determined. The learning history information may be attached to the learning data to be determined. The learning history information associated with the learning data to be determined is information indicative of learning data learned in the past by artificial intelligence that has learned the learning data to be determined. The learning history information is information indicating, for each artificial intelligence, correspondence between artificial intelligence identification information for identifying the artificial intelligence and learning data identification information for identifying learning data learned in the past by the artificial intelligence. Furthermore, information indicative of an order in which pieces of learning data were learned by artificial intelligence may be included in the learning history information. For example, learning data identification information for identifying learning data learned in the past by artificial intelligence is associated with the artificial intelligence, and the recording controller 66 associates the learning data identification information associated with the artificial intelligence that has learned learning data to be determined with the learning data to be determined. For example, in a case where artificial intelligence α learned learning data A, B, and C in this order, information indicating that the artificial intelligence α learned the learning data A, B, and C in this order is associated with the learning data C as learning history information.

The learning controller 68 is configured to cause artificial intelligence to learn learning data. For example, the learning controller 68 causes artificial intelligence to learn influential learning data or non-influential learning data that has not been learned by the artificial intelligence in accordance with a purpose of learning of the artificial intelligence. More specifically, the learning controller 68 causes another artificial intelligence different from artificial intelligence that has learned learning data to be determined to learn influential learning data or non-influential learning data classified as a result of learning of the artificial intelligence in accordance with a purpose of the other artificial intelligence. Specifically, the learning controller 68 causes the other artificial intelligence to learn improving learning data or decreasing learning data classified as a result of learning of the artificial intelligence in accordance with a purpose of learning of the other artificial intelligence. The learning controller 68 may cause the other artificial intelligence to learn improving learning data or non-improving learning data classified as a result of learning of the artificial intelligence in accordance with a purpose of learning of the other artificial intelligence. For example, the other artificial intelligence may be designated by a user or may be designated in advance.

Processing of the learning controller 68 is described by using a specific example. For example, in a case where performance of a function a of artificial intelligence α has improved as a result of learning of learning data A and a purpose of learning of another artificial intelligence β is to improve the function a of the artificial intelligence β, the learning controller 68 causes the artificial intelligence β to learn the learning data A. That is, since the learning data A is classified as improving learning data that can improve performance of the function a, the learning controller 68 causes the artificial intelligence β to learn the learning data A that is improving learning data that improves performance of the function a. In other words, in a case where the purpose of learning of the artificial intelligence β is to make performance of the artificial intelligence β close to performance of the artificial intelligence α, the artificial intelligence β is caused to learn the learning data A that has improved performance of the artificial intelligence α.

Meanwhile, in a case where the purpose of learning of the artificial intelligence β is to not make the performance of the artificial intelligence β close to the performance of the artificial intelligence α, i.e., to make the performance of the artificial intelligence β different from the performance of the artificial intelligence α, the learning controller 68 causes the artificial intelligence β to learn decreasing learning data that has decreased the performance of the artificial intelligence α, non-influential learning data learned by the artificial intelligence α, or non-improving learning data learned by the artificial intelligence α. In this way, the artificial intelligence β having performance different from the artificial intelligence α is created.

A purpose of learning of artificial intelligence is, for example, designated by a user. For example, a user designates artificial intelligence (e.g., the artificial intelligence β) caused to learn learning data and a purpose of learning of the artificial intelligence by operating the UI unit 54. The learning controller 68 causes the artificial intelligence designated by the user to learn learning data that matches the purpose of learning designated by the user.

The learning controller 68 may cause the other artificial intelligence to learn influential learning data classified by learning of artificial intelligence having a function corresponding to a function of the other artificial intelligence. The function corresponding to the function of the other artificial intelligence may be the same function as the function of the other artificial intelligence or may be a function similar to the function of the other artificial intelligence (e.g., a function whose difference from the function of the other artificial intelligence is equal to or smaller than a threshold value).

For example, in a case where performance of the function a of the artificial intelligence α has improved as a result of learning of the learning data A by the artificial intelligence α, the learning controller 68 causes the other artificial intelligence β having the function a to learn the learning data A. That is, the learning controller 68 causes the artificial intelligence β to learn improving learning data that has improved performance of the artificial intelligence α. For example, the artificial intelligences α and β may be designated by a user or may be designated in advance.

Furthermore, the learning controller 68 may cause the other artificial intelligence to learn influential learning data classified by learning of artificial intelligence having a learning history corresponding to a learning history of the other artificial intelligence. The learning history corresponding to the learning history of the other artificial intelligence may be the same learning history as the learning history of the other artificial intelligence or may be a learning history similar to the learning history of the other artificial intelligence (e.g., a learning history whose difference from the learning history of the other artificial intelligence is equal to or smaller than a threshold value). The learning history is a history of learning data learned by artificial intelligence in the past.

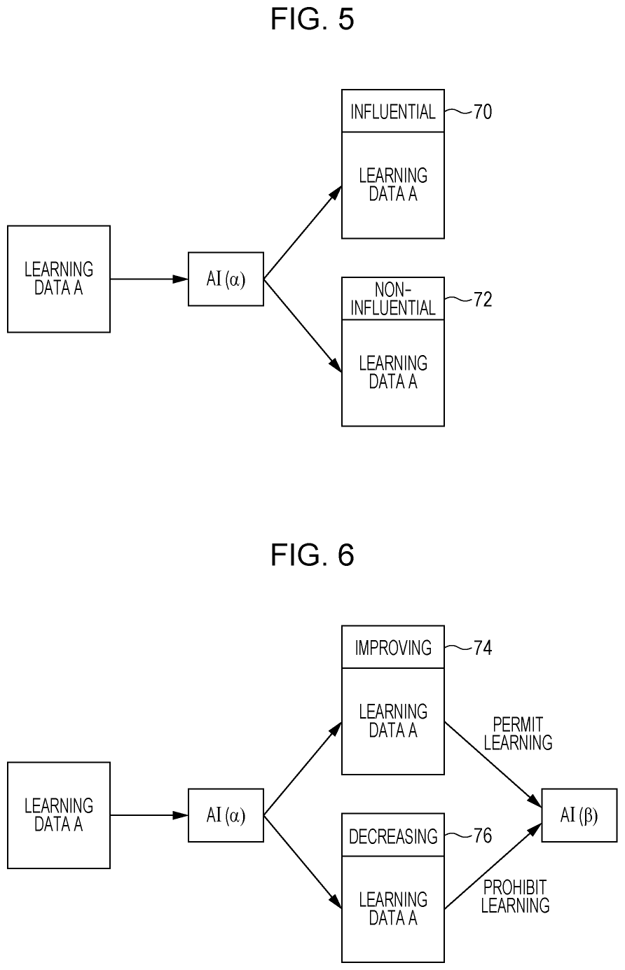

Processing of the information processing apparatus 50 is described below with reference to FIGS. 5 through 7. FIGS. 5 through 7 illustrate an example of learning data according to the second exemplary embodiment.

As illustrated in FIG. 5, for example, the learning data A is designated as learning data to be determined, and the artificial intelligence α (AI(α) in FIG. 5) is designated as artificial intelligence that learns the learning data A. For example, when a user gives an instruction to determine the learning data A by operating the UI unit 54, the determining unit 60 causes the artificial intelligence α to learn the learning data A to be determined and executes a test for determining whether or not the learning data A has influenced performance of the artificial intelligence α. That is, the determining unit 60 determines whether or not performance of the artificial intelligence α has changed before and after learning of the learning data A. In a case where performance of the artificial intelligence α has changed, the determining unit 60 determines that the learning data A is influential learning data that has influenced performance of the artificial intelligence α. In a case where the performance of the artificial intelligence α has not changed, the determining unit 60 determines that the learning data A is non-influential learning data that has not influenced the performance of the artificial intelligence α.

In a case where the learning data A is classified as influential learning data, the attaching unit 62 attaches determination result information 70 indicating that the learning data A is influential learning data to the learning data A, as illustrated in FIG. 5. In a case where the learning data A is classified as non-influential learning data, the attaching unit 62 attaches determination result information 72 indicating that the learning data A is non-influential learning data to the learning data A, as illustrated in FIG. 5.

The recording controller 66 may cause the learning data A classified as influential learning data or non-influential learning data to be recorded in the recording unit.

The determining unit 60 may determine whether or not performance of the artificial intelligence α has improved before and after learning of the learning data A. In a case where performance of the artificial intelligence α after learning of the learning data A has improved from performance of the artificial intelligence α before learning of the learning data A, the determining unit 60 determines that the learning data A is improving learning data that has improved performance of the artificial intelligence α. In this case, as illustrated in FIG. 6, the attaching unit 62 attaches determination result information 74 indicating that the learning data A is improving learning data to the learning data A. In a case where the performance of the artificial intelligence α after learning of the learning data A has decreased from the performance of the artificial intelligence α before learning of the learning data A, the determining unit 60 determines that the learning data A is decreasing learning data that has decreased performance of the artificial intelligence α. In this case, as illustrated in FIG. 6, the attaching unit 62 attaches determination result information 76 indicating that the learning data A is decreasing learning data to the learning data A.

The recording controller 66 may cause the learning data A classified as improving learning data or decreasing learning data to be recorded in the recording unit.

Furthermore, in a case where the learning data A is classified as improving learning data, the learning controller 68 may cause designated another artificial intelligence β (AI(β) in FIG. 6) to learn the learning data A. This can improve performance of the artificial intelligence β. Meanwhile, in a case where the learning data A is classified as decreasing learning data, the learning controller 68 may prohibit another artificial intelligence β to learn the learning data A. This prevents a decrease in performance of the artificial intelligence β.

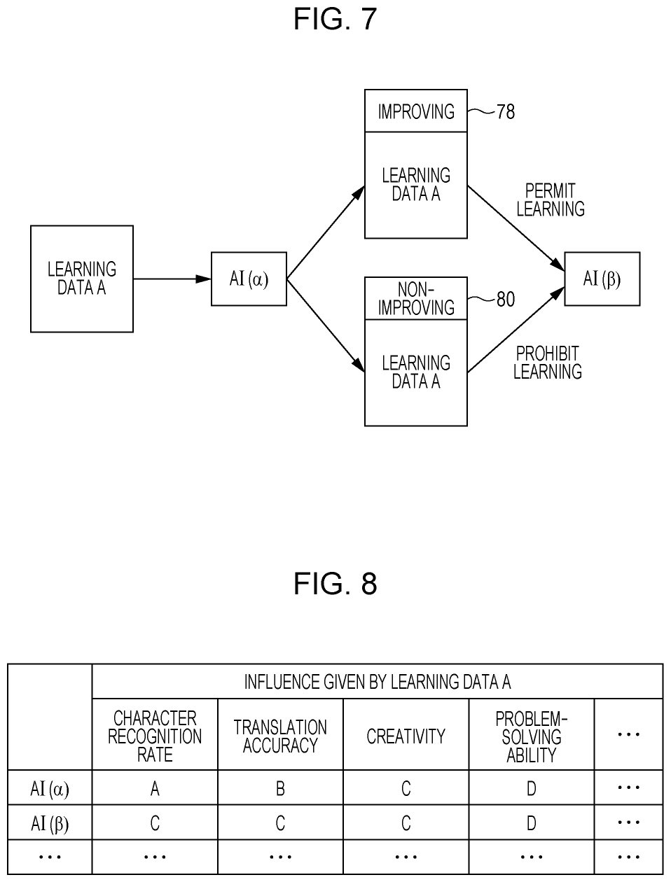

In a case where performance of the artificial intelligence α after learning of the learning data A has not improved from performance of the artificial intelligence α before learning of the learning data A, the determining unit 60 may determine that the learning data A is non-improving learning data that has not improved performance of the artificial intelligence α. In a case where the performance of the artificial intelligence α after learning of the learning data A has improved from the performance of the artificial intelligence α before learning of the learning data A, the determining unit 60 determines that the learning data A is improving learning data that has improved performance of the artificial intelligence α. In a case where the learning data A is classified as improving learning data, the attaching unit 62 attaches determination result information 78 indicating that the learning data A is improving learning data to the learning data A, as illustrated in FIG. 7. In a case where the learning data A is classified as non-improving learning data, the attaching unit 62 attaches determination result information 80 indicating that the learning data A is non-improving learning data to the learning data A, as illustrated in FIG. 7.

The recording controller 66 may cause the learning data A classified as improving learning data or non-improving learning data to be recorded in the recording unit.

Furthermore, in a case where the learning data A is classified as improving learning data, the learning controller 68 may cause another artificial intelligence β (AI(β) in FIG. 7) to learn the learning data A. This can improve performance of the artificial intelligence β. Meanwhile, in a case where the learning data A is classified as non-improving learning data, the learning controller 68 prohibits the other artificial intelligence β from learning the learning data A. This prevents a decrease in performance of the artificial intelligence β.

The determining unit 60 may determine, for each function of each artificial intelligence, influence given to the artificial intelligence by learning data and create management information (e.g., database) for managing a result of the determination. The management information may be stored in the storage unit 56 or may be stored in an apparatus other than the information processing apparatus 50.

FIG. 8 illustrates an example of a database that is an example of the management information. The database illustrated in FIG. 8 is a database indicative of a result of determination about influence given to artificial intelligence by the learning data A. In this database, information indicative of a result of determination about influence given to each artificial intelligence by the learning data A is managed for each function of the artificial intelligence.

For example, artificial intelligence α (AI(α) in FIG. 8) and artificial intelligence β (AI(β) in FIG. 8) each has functions such as a character recognition function, a translation function, creativity, and problem-solving ability. A determination result A indicates that performance has improved markedly. A determination result B indicates that performance has improved slightly. A determination result C indicates that performance has not changed. A determination result D indicates that performance has decreased.

As a result of learning of the learning data A, a character recognition rate of the artificial intelligence α has improved markedly, translation accuracy of the artificial intelligence α has improved slightly, creativity of the artificial intelligence α has not changed, and problem-solving ability of the artificial intelligence α has decreased. That is, performance of the character recognition function of the artificial intelligence α has improved markedly, performance of the translation function of the artificial intelligence α has improved slightly, performance of the creativity of the artificial intelligence α has not changed, and performance of the problem-solving ability of the artificial intelligence α has decreased.

As a result of learning of the learning data A, a character recognition rate, translation accuracy, and creativity of the artificial intelligence β have not changed, and problem-solving ability of the artificial intelligence β has decreased. That is, performance of the character recognition function, translation function, and creativity of the artificial intelligence β has not changed, and performance of the problem-solving ability of the artificial intelligence β has decreased.

Since determination results are managed as described above, influence given to performance of each artificial intelligence by learning data can be evaluated. In the example illustrated in FIG. 8, comparison between the artificial intelligence α and the artificial intelligence β shows that the performance of the artificial intelligence β has not improved as compared with the performance of the artificial intelligence α although both of the artificial intelligence α and the artificial intelligence β learn the same learning data A. In other words, the comparison shows that the performance of the artificial intelligence α has improved as compared with the performance of the artificial intelligence β.

Since there is sometimes a difference in learning history between the artificial intelligence α and the artificial intelligence β, it may be said that influence given to performance of artificial intelligences by the learning data A cannot be necessarily judged only from the determination results. However, the determination results can be used as one index for evaluating influence given to performance of the artificial intelligences by the learning data A.

Furthermore, in a case where learning histories of artificial intelligences are managed, it can be estimated what learning history artificial intelligence whose performance can be improved by learning of the learning data A has. For example, in a case where the artificial intelligence α and the artificial intelligence β use the same algorithm, it can be estimated what learning history artificial intelligence whose performance can be improved by learning of the learning data A has.

Furthermore, in a case where the artificial intelligence α and the artificial intelligence β use different algorithms, an algorithm by which performance of artificial intelligence improves as a result of learning of the learning data A can be estimated. In the example illustrated in FIG. 8, the performance of the artificial intelligence α improves as compared with the performance of the artificial intelligence β, and therefore it can be estimated that the algorithm by which performance of artificial intelligence improves as a result of learning of the learning data A is the algorithm used by the artificial intelligence α.

Furthermore, in a case where an algorithm used by artificial intelligence, a time of start of use, a time of start of learning, and a learning period of the artificial intelligence, and the like are managed as a database for each artificial intelligence, it can be estimated whether a factor of influence given to artificial intelligence by learning of learning data is the learning data or a reason (e.g., an algorithm or a learning history) other than the learning data.

A modification of the second exemplary embodiment is described below.

### First Modification of Second Exemplary Embodiment

A first modification of the second exemplary embodiment is described below. In the first modification of the second exemplary embodiment, the determining unit 60 causes artificial intelligence to learn a combination of plural different pieces of learning data and determines whether or not the combination of the plural pieces of learning data has influenced performance of the artificial intelligence. Then, the determining unit 60 classifies the combination of the plural pieces of learning data as a combination that has influenced performance of the artificial intelligence or a combination that has not influenced performance of the artificial intelligence.

The determining unit 60 may determine whether or not a combination of plural pieces of learning data has improved performance of artificial intelligence and classify the combination of plural pieces of learning data as a combination that has improved performance of the artificial intelligence or a combination that has decreased the performance of the artificial intelligence.

The determining unit 60 may determine whether or not a combination of plural pieces of learning data has improved performance of artificial intelligence and classify the combination of plural pieces of learning data as a combination that has improved performance of the artificial intelligence or a combination that has not improved performance of the artificial intelligence.

The attaching unit 62 attaches determination result information indicative of a result of determination of the determining unit 60 to a combination of plural pieces of learning data. The recording controller 66 may cause the combination to which the determination result information is attached to be recorded in the recording unit.

Causing artificial intelligence to learn a combination of plural pieces of learning data means concurrently giving the plural pieces of learning data to the artificial intelligence and causing the artificial intelligence to learn the plural pieces of learning data or giving pieces of learning data included in the plural pieces of learning data to the artificial intelligence in order and causing the artificial intelligence to learn the pieces of learning data in order.

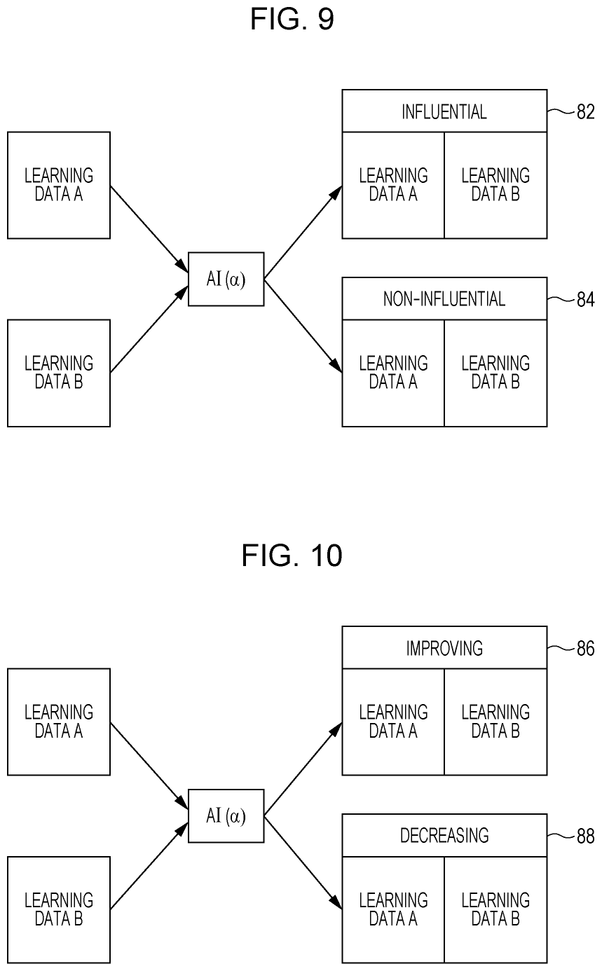

Processing according to the first modification of the second exemplary embodiment is described below with reference to FIGS. 9 through 11. FIGS. 9 through 11 illustrate an example of learning data according to the first modification of the second exemplary embodiment.

As illustrated in FIG. 9, for example, a combination of learning data A and B is designated as learning data to be determined, and artificial intelligence α (AI(α) in FIG. 9) is designated as artificial intelligence that learns the combination of learning data A and B. For example, when a user gives an instruction to determine the combination of learning data A and B by operating the UI unit 54, the determining unit 60 causes the artificial intelligence α to learn the combination of learning data A and B to be determined and executes a test for determining whether or not the combination of learning data A and B has influenced performance of the artificial intelligence α. That is, the determining unit 60 determines whether or not performance of the artificial intelligence α has changed before and after learning of the combination of learning data A and B. In a case where the performance of the artificial intelligence α has changed, the determining unit 60 determines that the combination of learning data A and B is a combination that has influenced the performance of the artificial intelligence α. In a case where the performance of the artificial intelligence α has not changed, the determining unit 60 determines that the combination of learning data A and B is a combination that has not influenced the performance of the artificial intelligence α.

In a case where the combination of learning data A and B is classified as a combination that has influenced performance of the artificial intelligence α, the attaching unit 62 attaches determination result information 82 indicating that the combination of learning data A and B is a combination that has influenced performance of the artificial intelligence α to the combination of learning data A and B, as illustrated in FIG. 9. In a case where the combination of learning data A and B is classified as a combination that has not influenced performance of the artificial intelligence α, the attaching unit 62 attaches determination result information 84 indicating that the combination of learning data A and B is a combination that has not influenced performance of the artificial intelligence α to the combination of learning data A and B, as illustrated in FIG. 9.

The recording controller 66 may cause the combination of learning data A and B classified as a combination that has influenced performance of the artificial intelligence α or a combination that has not influenced performance of the artificial intelligence α to be recorded in the recording unit.

The determining unit 60 may determine whether or not performance of the artificial intelligence α has improved before and after learning of the combination of learning data A and B. In a case where the performance of the artificial intelligence α after learning of the combination of learning data A and B has improved from the performance of the artificial intelligence α before learning of the combination of learning data A and B, the determining unit 60 determines that the combination of learning data A and B is a combination that has improved the performance of the artificial intelligence α. In this case, as illustrated in FIG. 10, the attaching unit 62 attaches determination result information 86 indicating that the combination of learning data A and B is a combination that has improved performance of the artificial intelligence α to the combination of learning data A and B. In a case where the performance of the artificial intelligence α after learning of the combination of learning data A and B has decreased from the performance of the artificial intelligence α before learning of the combination of learning data A and B, the determining unit 60 determines that the combination of learning data A and B is a combination that has decreased the performance of the artificial intelligence α. In this case, as illustrated in FIG. 10, the attaching unit 62 attaches determination result information 88 indicating that the combination of learning data A and B is a combination that has decreased the performance of the artificial intelligence α to the combination of learning data A and B.

The recording controller 66 may cause the combination of learning data A and B that is classified as a combination that has improved performance of the artificial intelligence α or a combination that has decreased performance of the artificial intelligence α to be recorded in the recording unit.

In a case where the combination of learning data A and B has improved performance of the artificial intelligence α, the learning controller 68 may cause designated another artificial intelligence (e.g., the artificial intelligence β) to learn the combination of learning data A and B. Meanwhile, in a case where the combination of learning data A and B has decreased performance of the artificial intelligence α, the learning controller 68 may prohibit another artificial intelligence from learning the combination of learning data A and B.

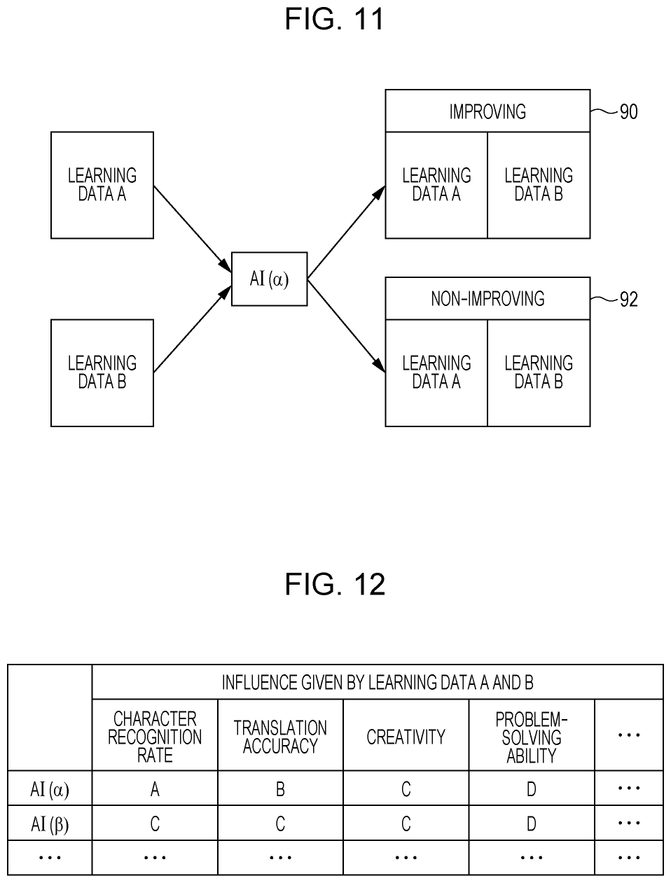

In a case where performance of the artificial intelligence α after learning of the combination of learning data A and B has not improved from performance of the artificial intelligence α before learning of the combination of learning data A and B, the determining unit 60 may determine that the combination of learning data A and B is a combination that has not improved the performance of the artificial intelligence α. In a case where the performance of the artificial intelligence α after learning of the combination of learning data A and B has improved from the performance of the artificial intelligence α before learning of the combination of learning data A and B, the determining unit 60 determines that the combination of learning data A and B is a combination that has improved the performance of the artificial intelligence α. In a case where the combination of learning data A and B is classified as a combination that has improved the performance of the artificial intelligence α, the attaching unit 62 attaches determination result information 90 indicating that the combination of learning data A and B is a combination that has improved the performance of the artificial intelligence α to the combination of learning data A and B, as illustrated in FIG. 11. In a case where the combination of learning data A and B is classified as a combination that has not improved the performance of the artificial intelligence α, the attaching unit 62 attaches determination result information 92 indicating that the combination of learning data A and B is a combination that has not improved the performance of the artificial intelligence α to the combination of learning data A and B, as illustrated in FIG. 11.

The recording controller 66 may cause the combination of learning data A and B classified as a combination that has improved the performance of the artificial intelligence α or a combination that has not improved the performance of the artificial intelligence α to be recorded in the recording unit.

In a case where the combination of learning data A and B is classified as a combination that has not improved performance of the artificial intelligence α, the learning controller 68 may prohibit another artificial intelligence from learning the combination of learning data A and B.

The determining unit 60 may determine, for each function of each artificial intelligence, influence given to the artificial intelligence by a combination of plural pieces of learning data and create management information (e.g., a database) for managing a result of the determination. The management information may be recorded in the storage unit 56 or may be recorded in an apparatus other than the information processing apparatus 10.

FIG. 12 illustrates an example of a database that is an example of the management information. The database illustrated in FIG. 12 is a database indicative of a result of determination about influence given to artificial intelligence by the combination of learning data A and B. In this database, information indicative of a result of determination about influence given to each artificial intelligence by the combination of learning data A and B is managed for each function of the artificial intelligence. Meanings of determination results A, B, C, and D are the same as the meanings of the determination results illustrated in FIG. 8.

As a result of learning of the combination of the learning data A and B, a character recognition rate of the artificial intelligence α has improved markedly, translation accuracy of the artificial intelligence α has improved slightly, creativity of the artificial intelligence α has not changed, and problem-solving ability of the artificial intelligence α has decreased. That is, performance of a character recognizing function of the artificial intelligence α has improved markedly, performance of a translation function of the artificial intelligence α has improved slightly, performance of creativity of the artificial intelligence α has not changed, and performance of problem-solving ability of the artificial intelligence α has decreased.

As a result of learning of the combination of the learning data A and B, a character recognition rate, translation accuracy, and creativity of the artificial intelligence β have not changed, and problem-solving ability of the artificial intelligence β has decreased. That is, performance of a character recognizing function, a translation function, and creativity of the artificial intelligence β have not changed, and performance of problem-solving ability of the artificial intelligence β has decreased.

Since determination results are managed as described above, influence given to performance of each artificial intelligence by a combination of plural pieces of learning data can be evaluated. In the example illustrated in FIG. 12, comparison between the artificial intelligence α and the artificial intelligence β shows that the performance of the artificial intelligence β has not improved as compared with the performance of the artificial intelligence α although both of the artificial intelligence α and the artificial intelligence β learn the same combination of the learning data A and B. In other words, the comparison shows that the performance of the artificial intelligence α has improved as compared with the performance of the artificial intelligence β.

In a case where artificial intelligence learns the learning data A and B in order, determination results obtained in a case where the order is changed may be managed in a database. That is, determination results obtained in a case where artificial intelligence learns the learning data A and B in an order of the learning data A and B and determination results obtained in a case where artificial intelligence learns the learning data A and B in an order of the learning data B and A may be managed in a database.

Although the determining unit 60 causes artificial intelligence to learn a combination of two pieces of learning data in the above example, the determining unit 60 may cause artificial intelligence to learn a combination of three or more pieces of learning data and determine influence of the learning.

The pieces of learning data included in the combination of plural pieces of learning data may be learning data of the same kind or the same format or may be learning data of different kinds or different formats. For example, a combination of plural pieces of document data or a combination of plural pieces of image data may be used as the combination of plural pieces of learning data. Alternatively, a combination of document data and image data may be used as the combination of plural pieces of learning data. These combinations are merely examples, and the pieces of learning data included in the combination of plural pieces of learning data may be designated by a user.

### Second Modification of Second Exemplary Embodiment

A second modification of the second exemplary embodiment is described below. In the second modification of the second exemplary embodiment, the determining unit 60 determines end of life of artificial intelligence. The “end of life” as used herein means that performance of artificial intelligence does not improve even in a case where the artificial intelligence learns learning data or that even in a case where the performance of the artificial intelligence improves, the improvement is less than a threshold value. Determination that artificial intelligence has reached end of life is used as a criterion for prompting a user to exchange the artificial intelligence or change an algorithm.

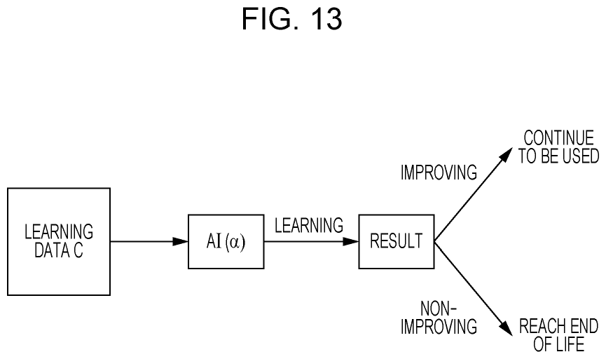

For example, as illustrated in FIG. 13, the determining unit 60 causes artificial intelligence α to learn learning data C that has not been learned by the artificial intelligence α and determines whether or not the performance of the artificial intelligence α has improved as a result of the learning. In a case where the performance of the artificial intelligence α has improved, the determining unit 60 determines that the artificial intelligence α has not reached end of life. In a case where the performance of the artificial intelligence α has not improved, the determining unit 60 determines that the artificial intelligence α has reached end of life. Even in a case where the performance of the artificial intelligence α has improved, the determining unit 60 may determine that the artificial intelligence α has reached end of life in a case where the improvement is less than a threshold value.

In a case where it is determined that the artificial intelligence α has reached end of life, the controller 64 may output information such as information indicative of recommendation to exchange the artificial intelligence or information indicative of recommendation to change an algorithm of the artificial intelligence. For example, the controller 64 may cause the information indicative of the recommendation to be displayed on the display of the UI unit 54 or may output voice.

Note that the determining unit 60 may cause the artificial intelligence α to learn the same learning data plural times successively or at predetermined time intervals and determine the end of life of the artificial intelligence α on the basis of a result of the learning.

The determining unit 60 may cause the artificial intelligence α to learn plural pieces of different learning data and determine the end of life of the artificial intelligence α on the basis of a result of the learning. For example, in a case where the number of pieces of learning data that have improved the performance of the artificial intelligence α is less than a threshold value, the determining unit 60 determines that the artificial intelligence α has reached end of life. In a case where the number of pieces of learning data that have improved the performance of the artificial intelligence α is equal to or larger than the threshold value, the determining unit 60 determines that the artificial intelligence α has not reached end of life.

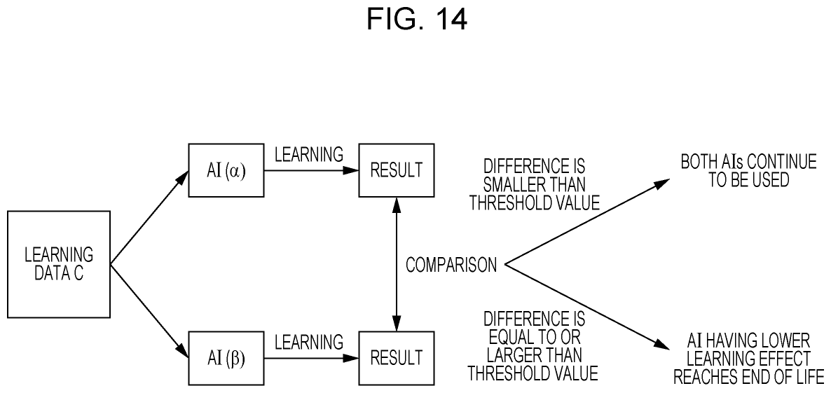

FIG. 14 illustrates another example. In the other example, as illustrated in FIG. 14, the determining unit 60 causes each of artificial intelligences α and β to learn learning data C that has not been learned by each of the artificial intelligences α and β and compares a result of the learning of the artificial intelligence α and a result of the learning of the artificial intelligence β. In a case where a difference between the result of the learning of the artificial intelligence α and the result of the learning of the artificial intelligence β is less than a threshold value, the determining unit 60 determines that each of the artificial intelligences α and β has not reached end of life. In a case where the different between the result of the learning of the artificial intelligence α and the result of the learning of the artificial intelligence β is equal to or larger than the threshold value, the determining unit 60 determines that artificial intelligence having a lower learning effect among the artificial intelligences α and β has reached end of life. The artificial intelligence having a lower learning effect is artificial intelligence whose performance has not improved as compared with performance of the other artificial intelligence, artificial intelligence whose performance has not improved while performance of the other artificial intelligence has improved, or artificial intelligence whose performance has decreased more than the performance of the other artificial intelligence although the performance of the other artificial intelligence has decreased.

The artificial intelligences α and β may be artificial intelligences having the same or similar learning history or may be artificial intelligences having learning histories that are not the same nor similar. A case where the learning histories are similar is a case where a difference between the learning history of the artificial intelligence α and the learning history of the artificial intelligence β is less than a threshold value.

The processing of the determining unit 60, the attaching unit 62, the recording controller 66, and the learning controller 68 may be executed by artificial intelligence. For example, artificial intelligence instructed to learn learning data may execute these kinds of processing.

Functions of the units of the information processing apparatuses 10 and 50 are realized, for example, by cooperation of hardware and software. Specifically, the information processing apparatuses 10 and 50 have one or more processors such as a CPU (not illustrated). The one or more processors read out and execute a program stored in a storage device (not illustrated), and thereby the functions of the units of the information processing apparatuses 10 and 50 are realized. The program is stored in the storage device through a recording medium such as a CD or a DVD or a communication path such as a network. In another example, the functions of the units of the information processing apparatuses 10 and 50 may be realized by a hardware resource such as a processor, an electronic circuit, or an application specific integrated circuit (ASIC). A device such as a memory may be used in realizing the functions of the units of the information processing apparatuses 10 and 50. In still another example, the functions of the units of the information processing apparatuses 10 and 50 may be realized, for example, by a digital signal processor (DSP) or a field programmable gate array (FPGA).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a receiving unit that receives learning data; and
a changing unit that changes learning processing of artificial intelligence in accordance with information attached to the learning data and indicating whether or not to permit the artificial intelligence to learn the learning data.

2. The information processing apparatus according to claim 1, wherein
in a case where the information indicates that the artificial intelligence is not permitted to learn the learning data, the changing unit prohibits the artificial intelligence from learning the learning data.

3. The information processing apparatus according to claim 2, wherein
in a case where the information indicates that the artificial intelligence is not permitted to learn the learning data, the changing unit permits the artificial intelligence to learn the learning data in a case where a purpose of learning using the learning data satisfies a criterion.

4. The information processing apparatus according to claim 2, further comprising an output unit that outputs a warning in a case where the information indicates that the artificial intelligence is not permitted to learn the learning data and where the learning data is about to be changed without permission.

5. The information processing apparatus according to claim 3, further comprising an output unit that outputs a warning in a case where the information indicates that the artificial intelligence is not permitted to learn the learning data and where the learning data is about to be changed without permission.

6. The information processing apparatus according to claim 2, further comprising a deleting unit that deletes the learning data in a case where the information indicates that the artificial intelligence is not permitted to learn the learning data and where the learning data is about to be changed without permission.

7. The information processing apparatus according to claim 3, further comprising a deleting unit that deletes the learning data in a case where the information indicates that the artificial intelligence is not permitted to learn the learning data and where the learning data is about to be changed without permission.

8. The information processing apparatus according to claim 1, wherein
in a case where the information indicates that the artificial intelligence is permitted to learn the learning data, the changing unit permits the artificial intelligence to learn the learning data.

9. The information processing apparatus according to claim 8, wherein
the information further includes information indicative of a period in which the artificial intelligence is permitted to learn the learning data.

10. The information processing apparatus according to claim 8, wherein
the information further includes information indicative of a limit on the number of times of learning of the learning data.

11. The information processing apparatus according to claim 1, wherein
the information further includes information indicating whether or not to permit the artificial intelligence to learn the learning data in accordance with usage of the learning data.

12. The information processing apparatus according to claim 1, wherein
the information further includes information indicating whether or not to permit the artificial intelligence to learn the learning data in accordance with a system of the artificial intelligence.

13. The information processing apparatus according to claim 1, wherein
the information includes, for each field of use of the artificial intelligence, information indicating whether or not to permit the artificial intelligence to learn the learning data.

14. An information processing apparatus comprising:
a receiving unit that receives learning data; and
a prohibiting unit that prohibits artificial intelligence from learning the learning data in a case where information indicating that the artificial intelligence is prohibited from learning the learning data is attached to the learning data.

15. An information processing apparatus comprising:
a receiving unit that receives learning data; and
a permitting unit that permits artificial intelligence to learn the learning data in a case where information indicating that the artificial intelligence is permitted to learn the learning data is attached to the learning data.

16. An information processing apparatus comprising an attaching unit that attaches information indicating whether or not content data is permitted to be used as learning data of artificial intelligence to the content data.

17. A non-transitory computer readable medium storing a program causing a computer to execute a process for image processing, the process comprising:
receiving learning data; and
changing learning processing of artificial intelligence in accordance with information attached to the learning data and indicating whether or not to permit the artificial intelligence to learn the learning data.

18. A non-transitory computer readable medium storing a program causing a computer to execute a process for image processing, the process comprising attaching information indicating whether or not content data is permitted to be used as learning data of artificial intelligence to the content data.
